(19) United States
(12) Patent Application Publication
(10) Pub. No.: US 2005/0287983 A1
(43) Pub. Date: Dec. 29, 2005

(54) System and method of managing SS7-monitored call information

(76) Inventors: Frederick Michael Armanino, San Antonio, TX (US); Raghvendra G. Savoor, Walnut Creek, CA (US); Stephen A. Sposato, Lafayette, CA (US); Mengfeng Tsai, Fremont, CA (US); Sam Cauble, San Ramon, CA (US)

Correspondence Address: TOLER & LARSON & ABEL L.L.P., 5000 PLAZA ON THE LAKE STE 265, AUSTIN, TX, 78746, US

(21) Appl. No.: 10/878,961

(22) Filed: Jun. 28, 2004

(51) Int. Cl. H04Q 7/00

(52) U.S. Cl. 455/405

(57) ABSTRACT

A system of managing call information is disclosed. The system comprises a call data record collection engine that non-intrusively monitors and collects data for calls routed using SS7 links coupled to telephone offices, a dynamic call record building engine to dynamically build call management records based on information retrieved by the call data record collection engine, and a relational data model for a subscriber including telephone numbers associated with the subscriber that are under call management. The call management records are correlated with the relational data model for the subscriber on a real-time basis. The call management records include a call time/data stamp, calling party information, called party information, a call type, geographic information, carrier information, a call disposition, and a call duration.

### FIELD OF THE DISCLOSURE

The present disclosure is generally related to a system and method of monitoring and managing call information.

### BACKGROUND

A conventional method to evaluate call management records for terminating and originating calls, including toll free calls, that use a public switched network, is to use billing statements (e.g., paper bill, CD, or E-bill). With this method, information is typically limited to a subset of the calls (i.e., only completed calls) and permits limited analysis. There are capital-intensive methods to provide further call information that rely on advanced intelligent network (AIN) triggers and special hardware, however, these methods are costly. In addition, the AIN methods are not integrated for real-time correlation for use with relational model or web-based real-time reporting functions.

Further, these methods are available only for certain services (i.e., AIN services) and on certain switch types (e.g., AIN capable switches). These methods also consume network billing system resources, have significant overhead and capital cost, and provide a limited scope and footprint of the call management function. Accordingly, there is a need for an improved call information management system.

### BRIEF DESCRIPTION OF THE DRAWINGS

FIG. 1 is a block diagram of a public-switched telephone network with added call management system elements.

FIG. 2 is a flow chart of a method of managing call information using the network and system of FIG. 1.

FIGS. 3-7 illustrate web-based navigational view displays.

The use of the same reference symbols in different drawings indicates similar or identical items.

### DESCRIPTION OF THE DRAWINGS

Embodiments of the present disclosure relate to a system of managing call information that comprises a call data record collection engine that non-intrusively monitors and collects data for calls routed using signaling system 7 (SS7) links coupled to telephone offices, a dynamic call record building engine to dynamically build call management records based on information retrieved by the call data record collection engine, and a relational data model for a subscriber including telephone numbers associated with the subscriber that are under call management. The call management records are correlated with the relational data model for the subscriber on a real-time basis. The call management records include a call time/data stamp, calling party information, called party information, a call type, geographic information, carrier information, a call disposition, and a call duration.

Embodiments of the present disclosure relate to a method of managing call information that comprises collecting call data using a centralized collection system that monitors a plurality of SS7 data links associated with a telephone network, dynamically generating call management records in response to the data collected by the centralized collection system, correlating the call management records in real-time with customized service bureau operation data models, and providing real-time reporting of call detail reports of originating and terminating calls, including uncompleted calls, via web access viewing.

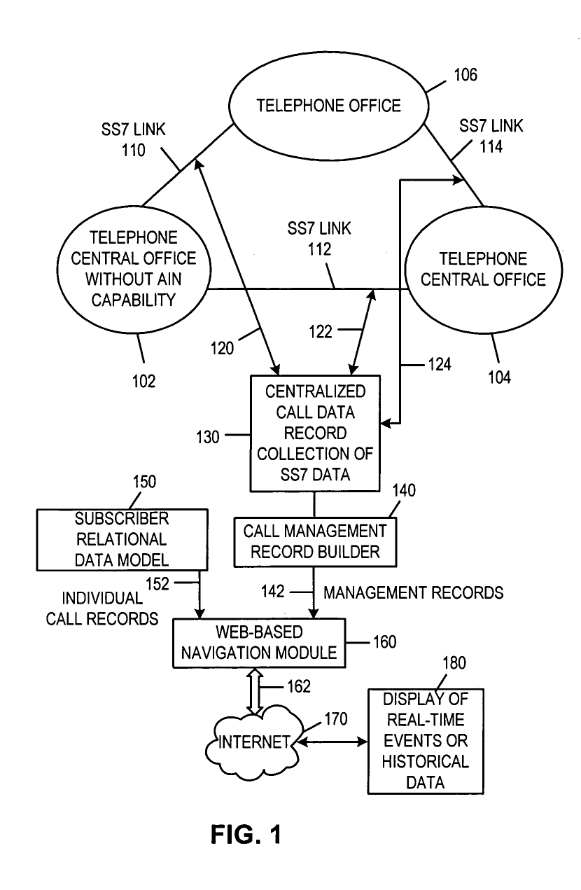

Referring to FIG. 1, a public-switched telephone network to be monitored for calling information is illustrated. The telephone network includes a first telephone central office 102 that does not have AIN capability, a second representative telephone central office 104, and a third representative telephone central office 106. The first telephone central office 102 is coupled to the second telephone central office 104 via a first representative SS7 link 112. Similarly, the first telephone central office 102 is coupled to the third telephone office 106 via a second SS7 link 110. The third telephone central office 106 is coupled to the second telephone central office 104 via a third representative SS7 link 114. While three telephone central offices have been shown for purposes of illustration, it should be understood that the public-switched telephone network includes a wide variety of geographically distributed central offices and associated SS7 links that may be monitored for calls that have been routed through the switched network. An example of a public switch network is the public switched telephone network (PSTN).

The system also includes a centralized call data record (CDR) collection module 130. The centralized CDR collection module non-intrusively monitors SS7 link data, being communicated between the various central offices. For example, the centralized CDR collection module 130 is coupled to the SS7 link 110 via a monitored link 120. Similarly, the centralized CDR collection engine 130 is coupled to SS7 link 112 via monitored link 122 and to SS7 link 114 via monitored link 124. While particular monitoring links have been shown, it should be understood that the centralized CDR collection module 130 may retrieve data either from monitoring the SS7 links directly or indirectly by connections to the central offices.

The centralized CDR collection module 130 is coupled to a call management record builder module 140. The call management record builder 140 receives call data records from the centralized CDR collection module 130 and produces call management records 142, which are passed to a web-based navigation module 160. The system further includes a subscriber relational data model 150 that is associated with particular subscriber telephone numbers and provides a relational data structure with respect to each of these subscriber numbers. The subscriber relational data model 150 produces individual call records 152 for each of the associated subscribers. The individual call records 152 and the call management records 142 are input to the web-based navigation module 160. The web-based navigation module 160 may be implemented as a computer workstation and/or a server connected to the Internet 170 via a representative data connection 162. In a particular embodiment, the web-based navigation module 160 may be coupled to the Internet 170 over a virtual private network (VPN) and such connection may handle data communication between the web-based navigation module 160 and various remote display terminals. An example of a display is the display terminal 180, which may be used to display real-time events or historical call management data.

During operation, a plurality of CDR information is non-intrusively monitored and collected by the centralized CDR module 130 via the monitoring of the SS7 data links within the public switch network. The centralized CDR collection module 130 then collects the monitored SS7 data in real-time and the call management record builder 140 dynamically generates call management records 142, which are archived at the web-based navigation module 160 to support real-time, or substantially near real-time, monitoring via web-based terminals that may be viewed by end users. In addition, during operation the call management records retrieved from the real-time monitoring of the SS7 links are correlated with respect to particular subscriber relational data models to provide for dynamic generation of display information and to provide convenient viewing of the real-time monitored information.

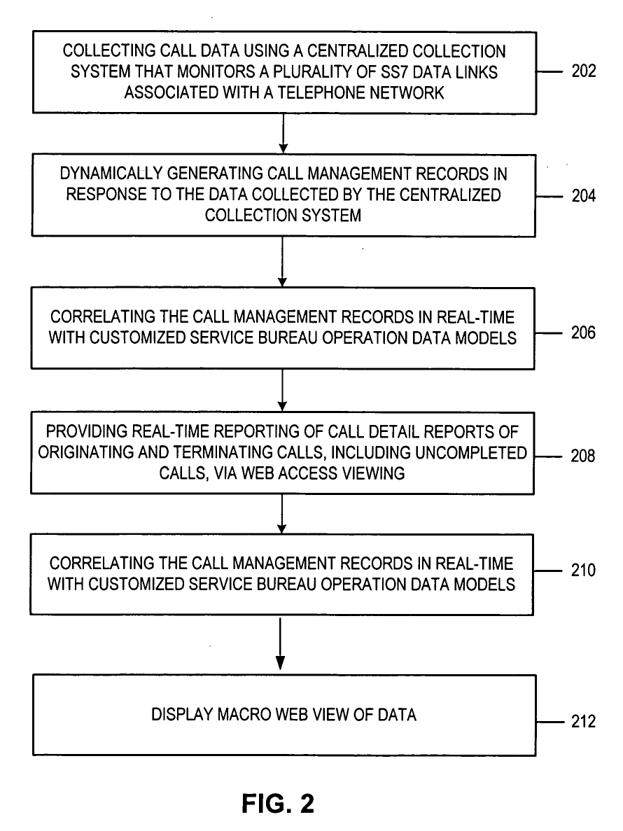

Referring to FIG. 2, a method of managing call information using the illustrated system of FIG. 1 is shown. The method includes collecting call data using the centralized CDR system that monitors a plurality of SS7 data links associated with a telephone network, at 202. Call management records are dynamically generated in response to the data collected by the centralized CDR system, as shown at 204. The call management records are correlated in real-time with subscriber relational data model information such as a service bureau operation data model, as shown at 206. An example of a service bureau is a call center that provides customer support or sales for toll free numbers. After correlating the call management records in real-time, the real-time correlated records are reported in a call detail report, which includes originating and terminating calls, and includes a variety of calls including calls that have not been completed, as shown at 208.

The real-time reports may be shown to customers or network operations personnel via web access viewing. The web access views may provide displays of data across multiple geographic locations and include multiple telephone numbers. For example, a particular subscriber may have a set of different toll free numbers and that subscriber may view data across all of their managed toll free numbers to monitor real-time data associated with calls placed to those toll free numbers. As shown at 212, macro web views for call volume data by place of origin, hour of day, call disposition, and historical call behavior may also be displayed. Such information presented in a macro view provides for convenient monitoring and useful feedback information for the subscriber having the particular set of toll free numbers. In addition, by providing historical call behavior, subscribers may compare the currently monitored real-time data to historical behavior to identify anomalies or trends. For example, a subscriber may notice an increased number of calls placed but not completed and may investigate the reasons for the uncompleted calls. Another example is where call queuing lines may be too long such that potential customers are hanging up prior to being routed to a service representative.

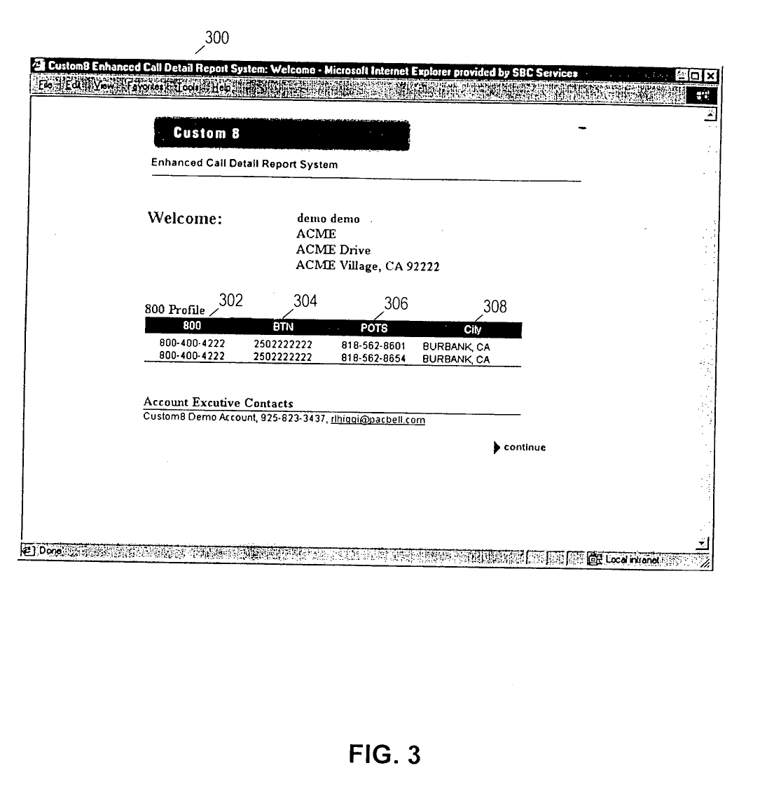

Referring to FIG. 3, an illustrative display of a web-based navigation view 300 is shown. The view 300 illustrates a particular display of toll free (e.g., 1-800) calls. The display includes a first field 302 to illustrate the 800 number, a second field 304 to illustrate a particular telephone number for a party placing the call, a third field 306 to identify a plain old telephone service (POTS) number corresponding to the call, and a fourth field 308 to illustrate an originating city for the call. The display also includes contact information such as a telephone number and email address that may be used to obtain further information relating to the call being managed or the application involved.

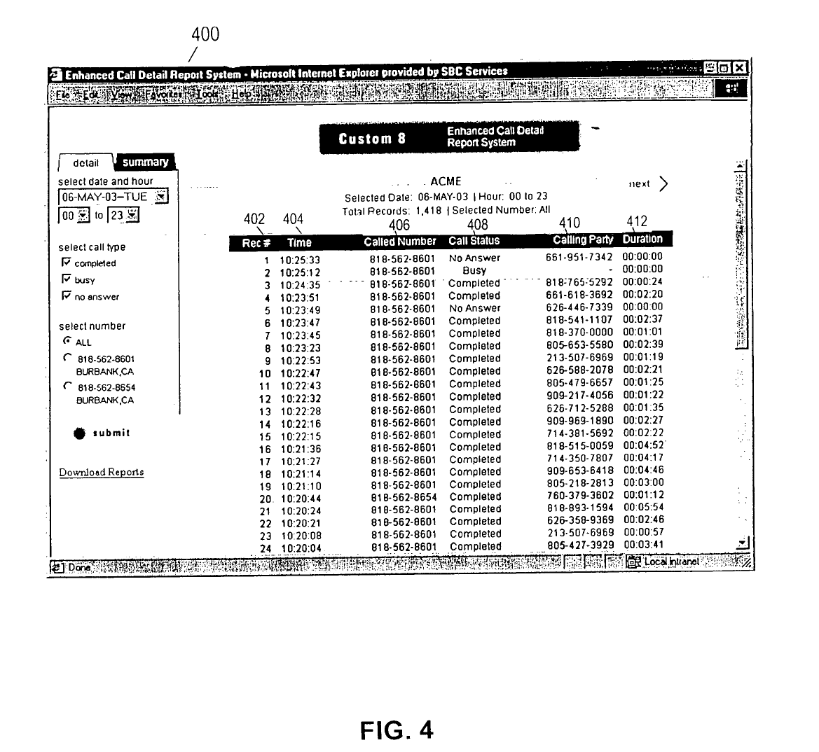

Referring to FIG. 4, another illustrative display 400 of a web-based navigation view is shown. The web-based view 400 includes a first field 402 to identify a call record number, a second field 404 to display a time stamp, a third field 406 to display the called number, a fourth field 408 to identify a call status, a fifth field 410 to identify a calling party number, and a sixth field 412 to illustrate the duration of the call. An example of the call status 408 is a call that was busy, a call that was completed, or a call that was not answered.

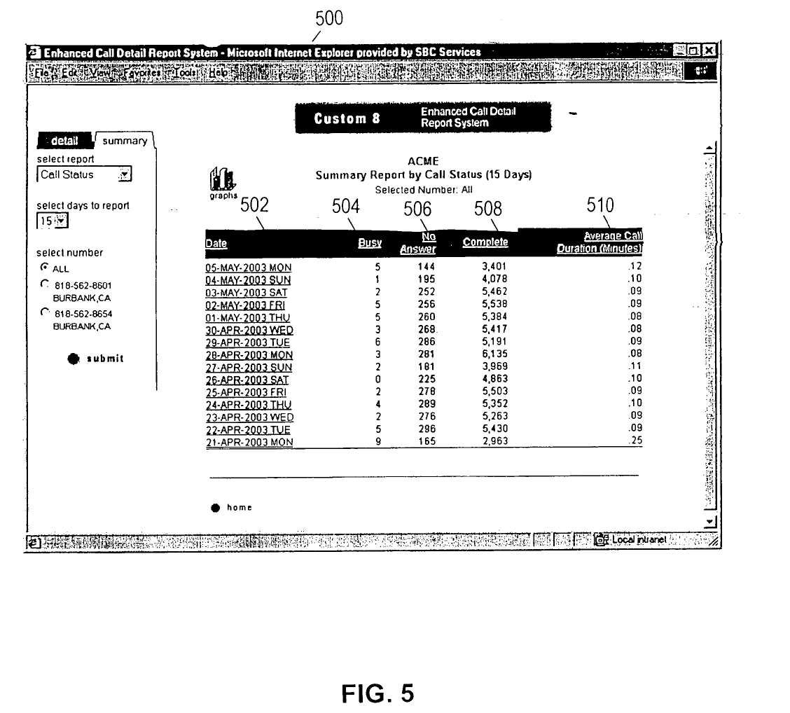

Referring to FIG. 5, another illustrative web-based navigation view 500 is shown. The web-based view 500 includes a first field 502 to illustrate a date of the call, a second field 504 to indicate a number of busy calls, a third field 506 to identify the number of no-answer calls, a fourth field 508 to identify the number of completed calls, and a fifth field 510 to identify the average call duration for the particular date of interest. When the call information is shown with the web-based view 500, a subscriber may evaluate performance of their service bureau, such as by comparing a number of completed calls to the number of busy or no-answer calls.

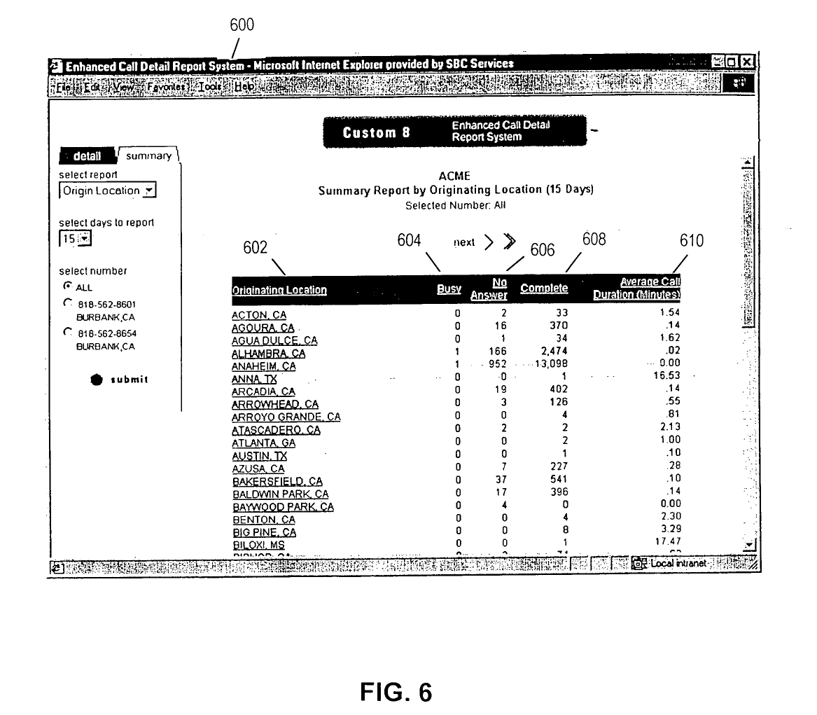

Referring to FIG. 6, another web-based navigation view 600 that may be displayed is shown. The web-based view 600 is a macro view that includes a first field 602 to identify originating call location, a second field 604 to identify a number of busy calls, a third field 606 to identify the number of non-completed calls or no answer calls, a fourth field 608 to identify the number of completed calls, and a fifth field 610 to identify the average call duration for each call recorded at a particular originating location.

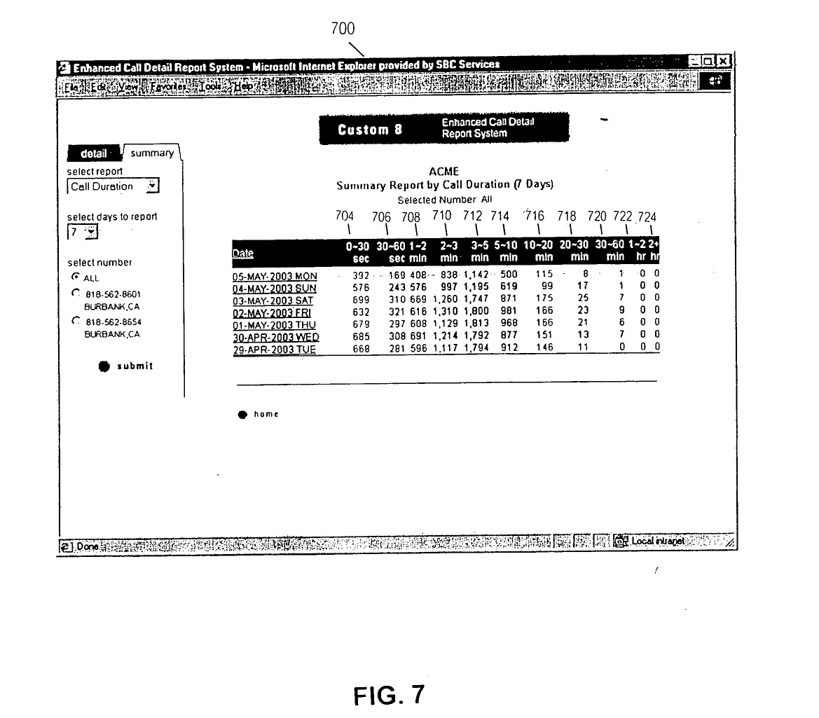

Referring to FIG. 7, another web-based macro view 700 is illustrated. The web-based view 700 provides a summary report that identifies various calls organized by their call duration. For example, the macro web-based view 700 includes a first field 702 that identifies a particular date for collected call records. The web-based view 700 also includes a plurality of different time duration segregated fields to indicate the number of calls within each particular call duration segment. For example, a number of calls having a duration of less than thirty seconds is shown, at field 704. As another example, the number of calls having a duration of greater than two hours is shown at field 724. As shown in FIG. 7, a variety of different call durations and the number of calls within each duration for a particular date is shown by various fields 704-724. Based on the macro view reports and the summary information presented, a subscriber of a calling service, such as a service bureau or toll free type service may gain useful real-time information for managing their telephony service and the related business.

The present disclosure is directed to a low-cost method, data model and interface that enables real-time (e.g., fifteen minutes or less) generation and correlation of call management detailed records for terminating and originating calls on single or multiple telephone numbers in the public switched network, including toll free services and ISDN/PRI numbers. The disclosed approach enables the collection, intelligent mapping, and presentation of call management records into intuitive views for use by users, such as service bureau operators (e.g., owner of the telephone numbers being managed).

The disclosed system and method may be used by service bureau operators across various industries that rely on the ability in real-time to manage their incoming and outgoing calls with high accuracy and that require visibility into all calls including missed calls (e.g., busy calls, unanswered calls, dropped calls etc.). Businesses in these industries can range from radio stations, Internet service providers, call centers (i.e., toll free services), or large enterprises with multiple locations. The information provided for incoming calls includes caller information, time of call, call disposition (i.e., answered, busy, unanswered, dropped), and call duration. The macro views include the geographic distribution of where callers are calling from, busy hour for the day, and average holding time across all their calls.

This method differs from conventional approaches by using a centralized vendor agnostic CDR collection architecture that non-intrusively monitors SS7 A-links at the end offices of interest, building call detail records dynamically for call attempts that come over the links, and by immediately correlating records with the relational data model of the subscriber. The relational data model for the subscriber includes all of the telephone numbers belonging to the subscriber that are being managed by the application. The correlated detailed records and macro views along with intuitive search functions may be available every fifteen minutes—or in real-time for subscribers with greater than fifteen calls/minute—via a secure web interface that the service bureau operator can access over the public Internet via a virtual private network (VPN).

The disclosed system and method provides an improved implementation of call management services for telecommunication providers while providing enhanced features and capabilities to service bureau operators. For example, the disclosed system supports a low cost centralized implementation architecture that is scalable on an incremental basis. The system provides dynamic and real-time generation of call management records, the ability to handle traffic volumes (e.g., sixty calls/minute per telephone number), and real-time visibility to call detail reports via web access of originating and terminating calls including calls that were not completed (busy, and not answered). The system also provides integrated web views for service bureau operators across multiple locations and telephone numbers, and secure web access to application views.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A system of managing call information, the system comprising:
a call data record collection engine that non-intrusively monitors and collects data for calls routed using SS7 links coupled to telephone offices;
a dynamic call record building engine to dynamically build call management records based on information retrieved by the call data record collection engine, the call management records including a call time/data stamp, calling party information, called party information, a call type, geographic information, carrier information, a call disposition, and a call duration; and
a relational data model for a subscriber including telephone numbers associated with the subscriber that are under call management, wherein the call management records are correlated with the relational data model for the subscriber on a real-time basis.

2. The system of claim 1, further comprising a web-based reporting module to provide reports of the dynamically built call management records correlated with the relational data model.

3. The system of claim 2, wherein the web-based reporting module provides tabular reports including call distribution by geography, call volume distribution by disposition code, call volume distribution based on hour of day, day of week, or days of the month, and call volume data across multiple telephone numbers.

4. The system of claim 1, wherein the call management records include trunk group information.

5. The system of claim 1, wherein the call disposition is selected from the group consisting of busy, not answered, failed with cause, and answered.

6. A method of managing call information, the method comprising:
collecting call data using a centralized collection system that monitors a plurality of SS7 data links associated with a telephone network;
dynamically generating call management records in response to the data collected by the centralized collection system;
correlating the call management records in real-time with customized service bureau operation data models; and
providing real-time reporting of call detail reports of originating and terminating calls, including uncompleted calls, via web access viewing.

7. The method of claim 6, wherein the web access viewing provides views across multiple locations and multiple telephone numbers.

8. The method of claim 6, wherein the web access viewing provides macro web views of call volumes by place of origin, hour of day, call disposition, and historical call behavior.

9. The method of claim 6, wherein the web access viewing is provided using a secure website.

10. A system comprising: a centralized call data record collection module to collect call data records from a plurality of different signaling system 7 (SS7) data links at end central telephone offices, at least one of the end central telephone offices without advanced intelligent network (AIN) capability; a dynamic call management record builder responsive to the centralized call data record collection module, the dynamic call management record builder to create call management records including call time/date stamp, calling party information, called party information, call type, jurisdiction indicator, carrier information, call disposition, call duration, and trunk group; a relational data model to enable reporting of each individual call management record and to provide at least one macro view of originating/terminating call distribution data organized by geography, call volume distribution by disposition code, call volume distribution by hour of day and day of week, and wherein the at least one macro view displays call volume information across multiple phone numbers of a common subscriber; and a web-based navigation module responsive to the relational data model and the record builder, the web-based navigation module to display real-time events or historical data relating to the call management records and to the at least one macro view.

11. The system of claim 10, wherein the call disposition indicates missed calls.

12. The system of claim 10, wherein the call disposition indicates unanswered calls.

13. The system of claim 10, wherein the call type is one of a forwarded call and a third party billed call.

14. The system of claim 10, wherein the SS7 data links are non-obtrusively monitored.

15. The system of claim 10, wherein the real-time events displayed are communicated remotely over a virtual private network connection via the internet for viewing by a service bureau operator.

16. The system of claim 10, wherein a summary report is displayed that includes a first field to indicate a call date, a second field to indicate a number of busy calls received, a third field to indicate a number of no-answer calls attempted, and-a fourth field to indicate an average call duration.

17. The system of claim 10, wherein a summary report is displayed that includes an origination location for a plurality of recorded call records.

18. The system of claim 10, wherein a summary report is displayed that includes a plurality of different call duration fields that indicate a number of call records having different call duration times.
